(19) United States
(12) Patent Application Publication
(10) Pub. No.: US 2011/0126808 A1
(43) Pub. Date: Jun. 2, 2011

(54) FUEL SUPPLY EQUIPMENT

(75) Inventors: Hideo MITSUDOU, Chiyoda-ku (JP); Masaru HIRAIWA, Chiyoda-ku (JP)

(73) Assignee: MITSUBISHI ELECTRIC CORPORATION, Tokyo (JP)

(21) Appl. No.: 12/768,470

(22) Filed: Apr. 27, 2010

(30) Foreign Application Priority Data
Dec. 1, 2009 (JP) 2009-273483

(51) Int. Cl. F02M 37/04; F02M 37/00; F16K 31/06

(52) U.S. Cl. 123/509; 123/511; 123/514; 137/544

(57) ABSTRACT

A fuel supply equipment includes: a lid member provided with a fuel discharge pipe; a fuel pump held by the lid member and configured to suck in fuel within the fuel tank and discharge the fuel to an outside of the fuel tank from the fuel discharge pipe; a suction filter that filters the fuel within the fuel tank that will be sucked into the fuel pump; a fuel filter that removes foreign matter in the fuel discharged from the fuel pump; a pressure regulator configured to adjust a pressure of the fuel discharged from the fuel filter to a predetermined pressure and discharge excess fuel; a case configured to accommodate the fuel pump, the suction filter, the fuel filter, and the pressure regulator; and a supporting member provided to the lid member to support the case on the lid member.

### BACKGROUND OF THE INVENTION

1. Field of the Invention

The present invention relates to a fuel supply equipment attached to a bottom wall of a fuel tank storing fuel and including a lid member filled in an opening made in the bottom wall and provided with a fuel discharge pipe and a fuel pump held by the lid member and configured to suck in fuel within the fuel tank and discharge the fuel to the outside of the fuel tank from the fuel discharge pipe.

2. Description of the Related Art

A fuel supply equipment in the related art used in a vehicle, such as a two-wheeled motor vehicle, includes a lid member that clogs an opening made in the bottom wall of the fuel tank, a fuel pump that discharges fuel, a fuel filter that filters fuel discharged from the fuel pump, and a filter case that accommodates and supports the foregoing members. The filter case is supported on the lid member with a supporting member. An example of this configuration is described in Japanese Patent No. 4203751 (Publication Date: 2009. Jan. 7) with reference to FIG. 1.

The lid member is formed in a bottomed tubular shape and has a lid portion and a tube portion. The lid member and the filter case are joined by engaging a window in the tube portion with a claw of the filter case using a snap fit. Accordingly, the lid member supports the fuel supply equipment. An example of this configuration is described in Japanese Patent No. 4203751 (Publication Date: 2009. Jan. 7) with reference to FIG. 4.

According to the configurations described above, excess fuel discharged from a pressure regulator is accumulated in the tube portion of the lid member of a bottomed tubular shape, so that running out of fuel occurring, for example, when the vehicle has inclined, is prevented by letting a suction filter suck in the accumulated excess fuel.

The fuel supply equipment in the related art described above has the lid member of a bottomed tubular shape configured to accumulate excess fuel discharged from the pressure regulator in the tube portion. However, because this configuration makes the lid member larger in size, there arises a problem that a mold cost is increased. Also, because the suction filter directly sucks in air bubbles contained in excess fuel discharged from the pressure regulator, there arises another problem that fuel supplied from the fuel supply equipment contains considerable air bubbles and adverse effects are given to the engine to which the fuel is supplied.

### SUMMARY OF THE INVENTION

The invention was devised to solve the problems discussed above and has an object to provide a fuel supply equipment that neither increases an initial cost, such as a mold cost, nor gives adverse effects to the engine to which the fuel is supplied.

A fuel supply equipment according to an aspect of the invention is attached to a bottom wall of a fuel tank storing fuel and includes: a lid member filled in an opening made in the bottom wall and provided with a fuel discharge pipe; a fuel pump held by the lid member and configured to suck in the fuel within the fuel tank and discharge the fuel to an outside of the fuel tank from the fuel discharge pipe; a suction filter provided on a suction side of the fuel pump to filter the fuel within the fuel tank that will be sucked into the fuel pump; a fuel filter provided on a discharge side of the fuel pump to remove foreign matter in the fuel discharged from the fuel pump; a pressure regulator configured to adjust a pressure of the fuel discharged from the fuel filter to a predetermined pressure and discharge excess fuel of the fuel; a case configured to accommodate the fuel pump, the suction filter, the fuel filter, and the pressure regulator and accumulate therein the excess fuel discharged from the pressure regulator; and a supporting member provided to the lid member to support the case on the lid member.

A fuel supply equipment according to another aspect of the invention is attached to a bottom wall of a fuel tank storing fuel and includes: a lid member filled in an opening made in the bottom wall and provided with a fuel discharge pipe; a fuel pump held by the lid member and configured to suck in the fuel within the fuel tank and discharge the fuel to an outside of the fuel tank from the fuel discharge pipe; a suction filter provided on a suction side of the fuel pump to filter the fuel within the fuel tank that will be sucked into the fuel pump; a fuel filter provided on a discharge side of the fuel pump to remove foreign matter in the fuel discharged from the fuel pump; a pressure regulator configured to adjust a pressure of the fuel discharged from the fuel filter to a predetermined pressure and discharge excess fuel of the fuel; and a case configured to accommodate the fuel pump, the suction filter, the fuel filter, and the pressure regulator and accumulate therein the excess fuel discharged from the pressure regulator. The lid member and the case are made of thermoplastic resin and the lid member and the case are fixedly attached to each other by thermal welding.

It thus becomes possible to obtain a fuel supply equipment that neither increases an initial cost, such as a mold cost, nor gives adverse effects to the engine to which the fuel is supplied.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is an outward perspective view showing a fuel supply equipment according to a first embodiment of the invention;

FIG. 2 is an exploded perspective view showing the fuel supply equipment according to the first embodiment of the invention;

FIG. 3 is a cross section of the fuel supply equipment according to the first embodiment of the invention taken on line A-A of FIG. 1;

FIG. 4 is a cross section of the fuel supply equipment according to the first embodiment of the invention taken on line B-B of FIG. 1;

FIG. 5 is an enlarged cross section of a major portion of the fuel supply equipment according to the first embodiment of the invention; and

FIG. 6 is a cross section showing a fuel supply equipment according to a second embodiment of the invention.

### DETAILED DESCRIPTION OF THE INVENTION

### First Embodiment

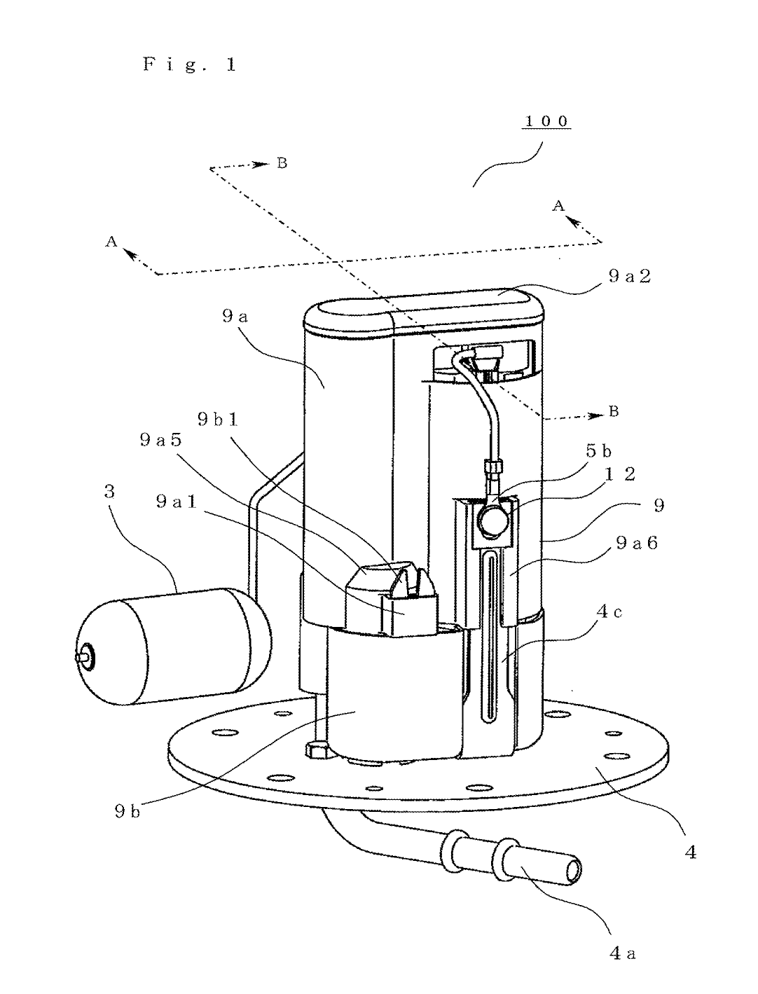

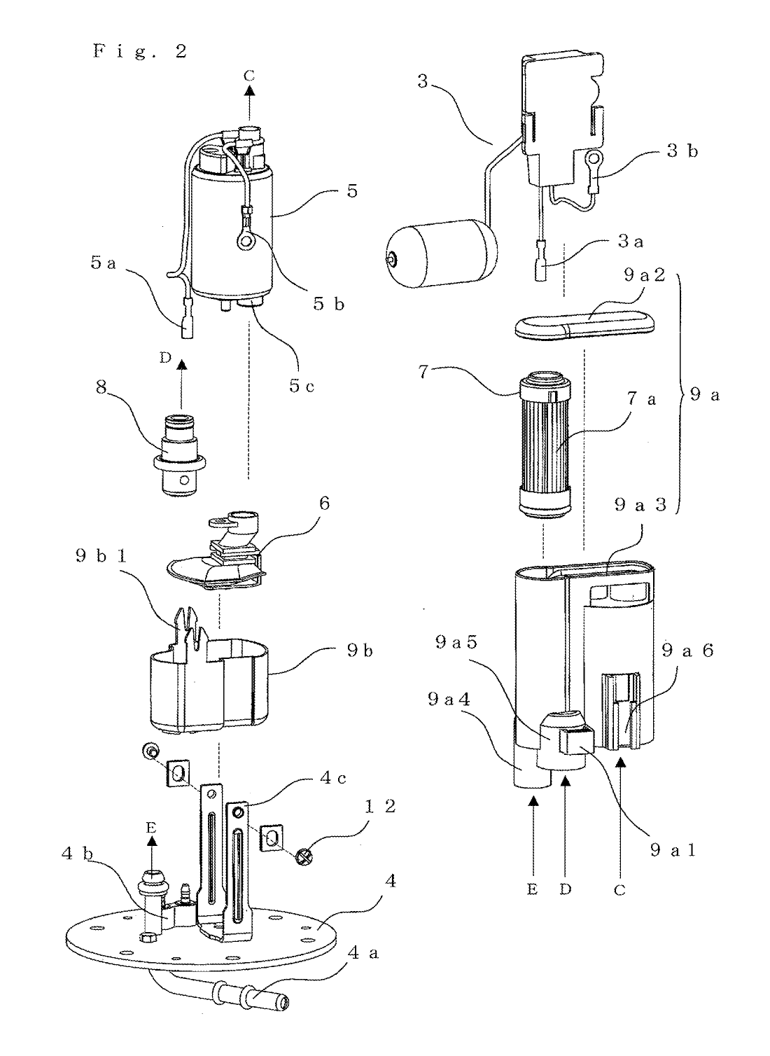

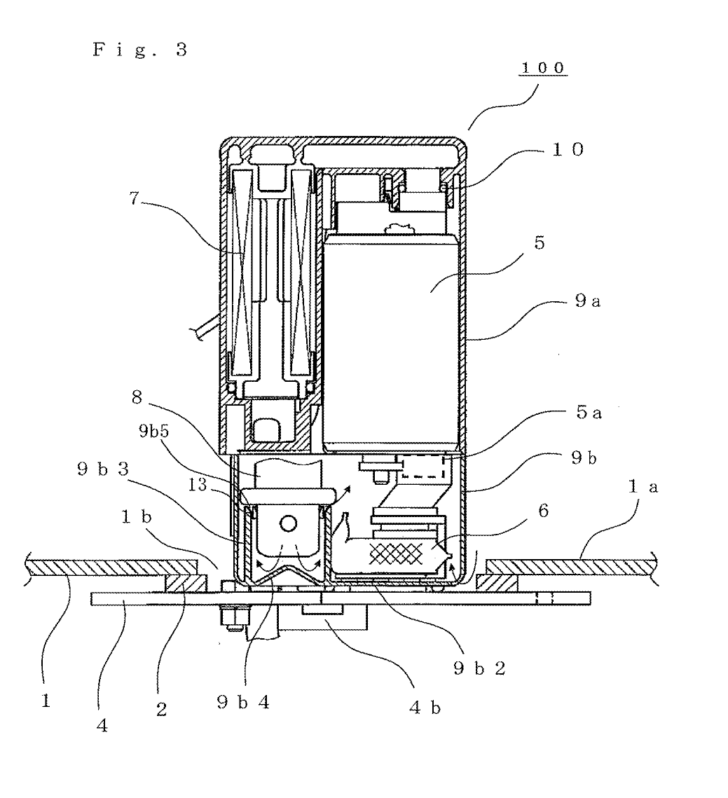

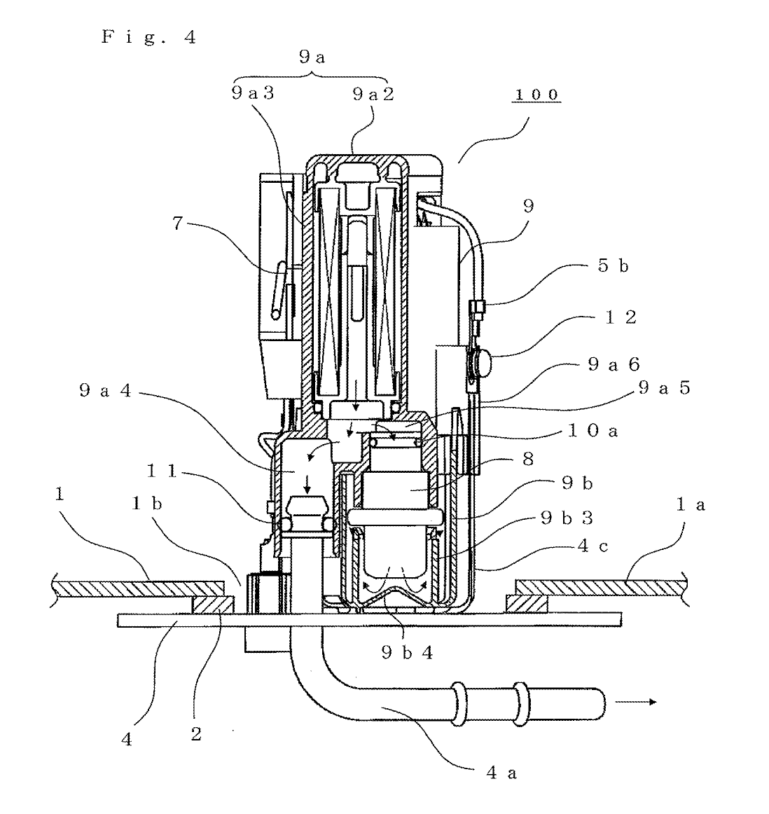

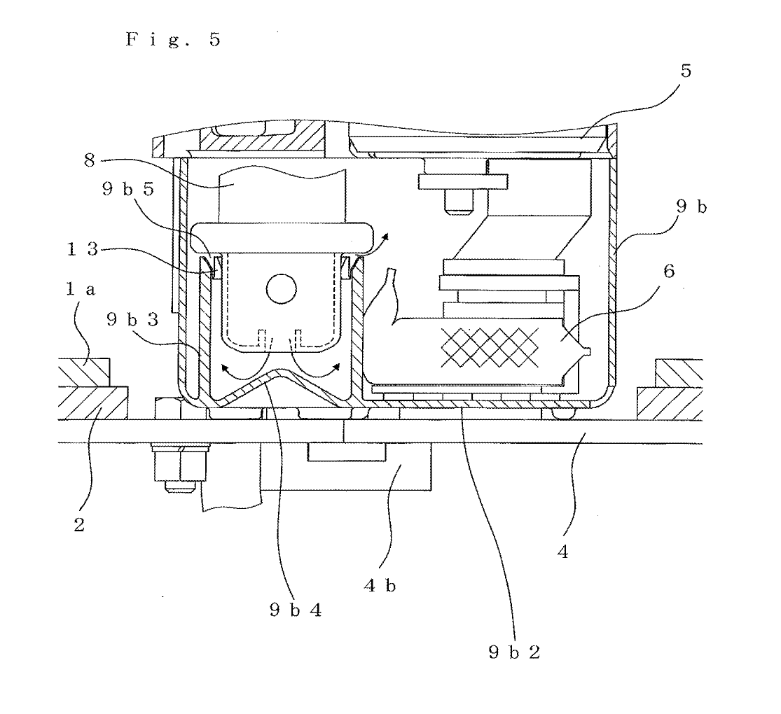

Hereinafter, a first embodiment of the invention will be described on the basis of FIG. 1 through FIG. 5. FIG. 1 is an outward perspective view showing a fuel supply equipment according to the first embodiment of the invention. FIG. 2 is an exploded perspective view showing the fuel supply equipment according to the first embodiment of the invention. FIG. 3 is across section of the fuel supply equipment according to the first embodiment of the invention taken on line A-A of FIG. 1. FIG. 4 is a cross section of the fuel supply equipment according to the first embodiment of the invention taken on line B-B of FIG. 1. FIG. 5 is an enlarged cross section of a major portion of the fuel supply equipment according to the first embodiment of the invention.

Referring to these drawings, a fuel supply equipment 100 is filled in an opening 1b made in a bottom wall 1a of a fuel tank 1 for two-wheeled motor vehicle, which is one type of vehicle, using an unillustrated bolt via a packing 2 formed, for example, of a rubber plate.

A flange 4 serving as a lid member that covers the opening 1b of the fuel supply equipment 100 is formed of an iron plate in a disc shape. A fuel discharge pipe 4a, an electric connector 4b, and an attachment stay 4c serving as a supporting member are integrally molded with the flange 4.

The fuel discharge pipe 4a provided to the flange 4 is a tube that delivers fuel discharged from a fuel pump 5 described below to the outside of the fuel tank 1. In other words, fuel discharged from the fuel pump 5 is supplied to the engine installed outside the fuel tank 1 via the fuel discharge pipe 4a.

The electric connector 4b provided to the flange 4 is electrically connected to the fuel pump 5 and a liquid level gauge 3 with a lead wire 5a of the fuel pump 5 and a lead wire 3a of the liquid level gauge 3, respectively.

Besides the flange 4, the fuel supply equipment 100 has the fuel pump 5 that sucks in fuel within the fuel tank 1 and discharges the fuel, a suction filter 6 provided on the suction side of the fuel pump 5 to filter fuel within the fuel tank 1 that will be sucked into the fuel pump 5, a fuel filter 7 provided on the discharge side of the fuel pump 5 to remove foreign matter in fuel discharged from the fuel pump 5 using a filter element 7a formed of filter paper, such as non-woven fabric, a pressure regulator 8 not only adjusting a pressure of fuel discharged from the fuel filter 7 to a predetermined pressure but also discharging excess fuel of fuel discharged from the fuel filter 7, and a case 9 accommodating the fuel pump 5, the suction filter 6, the fuel filter 7, and the pressure regulator 8 and made, for example, of resin.

The case 9 is formed of a first case 9a that accommodates the fuel pump 5 and the fuel filter 7 and a second case 9b that accommodates the pressure regulator 8 and the suction filter 6. The first case 9a and the second case 9b are fixedly attached to each other by locking an engaging convex portion 9b1 of the latter in an engaging concave portion 9a1 of the former (shown in FIG. 2) with a snap fit serving as a latching means.

The first case 9a is formed of a case cover 9a2 and a case main body 9a3 and the former and the latter are fixedly attached to each other, for example, by known thermal plate welding after the fuel filter 7 is fit by insertion into the case main body 9a3.

In addition, excess fuel discharged from the pressure regulator 8 is accumulated in the second case 9b.

The fuel pump 5 and the pressure regulator 8 are accommodated in and fixed to the first case 9a, respectively, via O-rings 10 and 10a (shown in FIG. 3 and FIG. 4, respectively) serving as airtight members.

The fuel pump 5 is provided with a suction opening 5c (shown in FIG. 2) through which to suck in fuel within the fuel tank 1. The suction filter 6 that filters out dirt in the fuel is fixedly attached to the suction opening 5c.

The second case 9b is a component in which excess fuel discharged from the pressure regulator 8 is accumulated so that the accumulated excess fuel is sucked into the suction filter 6.

Air bubble suppressing members 9b3 and 9b4 (shown in FIG. 5) that suppress air bubbles in excess fuel discharged from the pressure regulator 8 are provided to a bottom portion 9b2 of the second case 9b.

The air bubble suppressing member 9b3 is formed of a tubular body provided to an excess fuel discharge portion of the pressure regulator 8. The air bubble suppressing member 9b4 is formed of a conical body provided consecutively with the bottom portion of the air bubble suppressing member 9b3 formed of a tubular body. The drawings shows a case where the second case 9b and the air bubble suppressing members 9b3 and 9b4 are integrally molded using a resin material by way of example.

The first case 9a is of an elliptical flat shape. As is shown in FIG. 2, the fuel pump 5 is inserted into the right side of the case main body 9a3 from below as is indicated by an arrow C and the fuel filter 7 having a small diameter and formed long in the longitudinal direction is inserted into the left side of the case main body 9a3 from above. When configured in this manner, the assembling performance when attaching the fuel supply equipment 100 to the fuel tank 1 can be enhanced.

As with the first case 9a, the second case 9b is also of an elliptical flat shape. As is shown in FIG. 2, the suction filter 6 is accommodated on the right side of the second case 9b and the pressure regulator 8 is accommodated on the left side of the second case 9b.

The upper side of the pressure regulator 8 is attached by insertion into a second discharge chamber 9a5 formed in the case main body 9a3 of the first case 9a from below as is indicated by an arrow D.

As is shown in FIG. 4, part of fuel discharged from the fuel filter 7 flows in from the upper side of the pressure regulator 8 provided in the second discharge chamber 9a5 formed in the case main body 9a3 of the first case 9a, so that a pressure of the fuel discharged from the fuel filter 7 is adjusted. Excess fuel flown into the pressure regulator 8 is then discharged from the pressure regulator 8.

The fuel discharge pipe 4a is attached by insertion into a first discharge chamber 9a4 formed in the case main body 9a3 of the first case 9a from below as is indicated by an arrow E (shown in FIG. 2) by inserting through the second case 9b.

As is indicated by arrows of FIG. 4, fuel discharged from the fuel filter 7 is discharged into the first discharge chamber 9a4 formed in the case main body 9a3 of the first case 9a. The fuel discharged into the first discharge chamber 9a4 is then supplied to the outside of the fuel tank 1 through the fuel discharge pipe 4a.

With the case 9 accommodating the fuel pump 5, the suction filter 6, the fuel filter 7, and the pressure regulator 8 as described above, the fuel discharge pipe 4a provided to the flange 4 is fit by insertion into the first discharge chamber 9a4 of the first case 9a via an O-ring 11 (shown in FIG. 4) serving as an airtight member while an earth wire 5b of the fuel pump 5 and an earth wire 3b of the liquid level gauge 3 are attached fixedly by a fastening member 12 after the attachment stay 4c serving as a supporting member is fit by insertion into a fit-insertion portion 9a6 of the first case 9a.

In the fuel supply equipment 100 according to the first embodiment of the invention configured as above, when the fuel pump 5 is driven, an impeller serving as a rotation member rotating with a motor serving as an electric drive portion not shown herein inside the fuel pump 5 starts to rotate and fuel within the fuel tank 1 is sucked in and discharged in association with rotations of the impeller. Fuel within the fuel tank 1 is filtered while the fuel flows through the suction filter 6 in association with rotations of the bladed wheel of the impeller and then sucked into the fuel pump 5.

Subsequently, foreign matter in the fuel discharged from the fuel pump 5 is removed while the fuel flows through the filter element 7a of the fuel filter 7. The fuel discharged from the fuel filter 7 is adjusted to have a predetermined pressure by the pressure regulator 8 and discharged to the outside of the fuel tank 1 from the fuel discharge pipe 4a. The fuel is supplied further to injectors or the like of the internal combustion engine not shown herein.

In a case where the pressure of fuel discharged from the fuel filter 7 is higher than a predetermined value, excess fuel is returned into the second case 9b by the pressure regulator 8, so that the pressure is maintained at the predetermined value.

An operation for excess fuel discharged from the pressure regulator 8 to be returned to the second case 9b and accumulated therein will now be described.

Excess fuel discharged from the pressure regulator 8 contains air bubbles. Accordingly, when the suction filter 6 excessively sucks in air bubbles and fuel containing air bubbles is supplied to the engine through the fuel discharge pipe 4a, the supplied fuel can cause an engine malfunction. In order to avoid this inconvenience, it is necessary to prevent air bubbles from being sucked into fuel that will be supplied to the engine.

Because excess fuel discharged from the pressure regulator 8 flows into the air bubble suppressing member 9b3, it is configured in such a manner that excess fuel containing air bubbles does not directly fall on the suction filter 6 provided adjacently to the air bubble suppressing member 9b3. A convection flow is developed by a function of the conical shape of the air bubble suppressing member 9b4. Hence, not only are air bubbles contained in the excess fuel reduced but also air bubbles become smaller. The excess fuel in this state flows into the second case 9b from a top space 9b5 in the air bubble suppressing member 9b3.

Also, air bubbles remaining in the excess fuel flown into the second case 9b from the top space 9b5 in the air bubble suppressing member 9b3 are lighter than fuel and therefore rise up in the second case 9b. In other words, air bubbles rise up to a position remote from the suction filter 6. It thus becomes possible to lower a possibility that air bubbles are substantially sucked into the suction filter 6.

In the fuel supply equipment 100 according to the first embodiment of the invention configured as above, the second case 9b that not only accommodates the pressure regulator 8 and the suction filter 6 but also accumulates therein excess fuel discharged from the pressure regulator 8 can be compact. It thus becomes possible to obtain a fuel supply equipment capable of reducing an initial cost, such as a mold cost.

Also, air bubbles contained in excess fuel discharged from the pressure regulator 8 are reduced markedly by the air bubble suppressing members 9b3 and 9b4 and rise up in the second case 9b. Accordingly, air bubbles are hardly sucked in through the suction filter 6. It thus becomes possible to obtain a fuel supply equipment that does not give adverse effects to the engine to which fuel is supplied.

### Second Embodiment

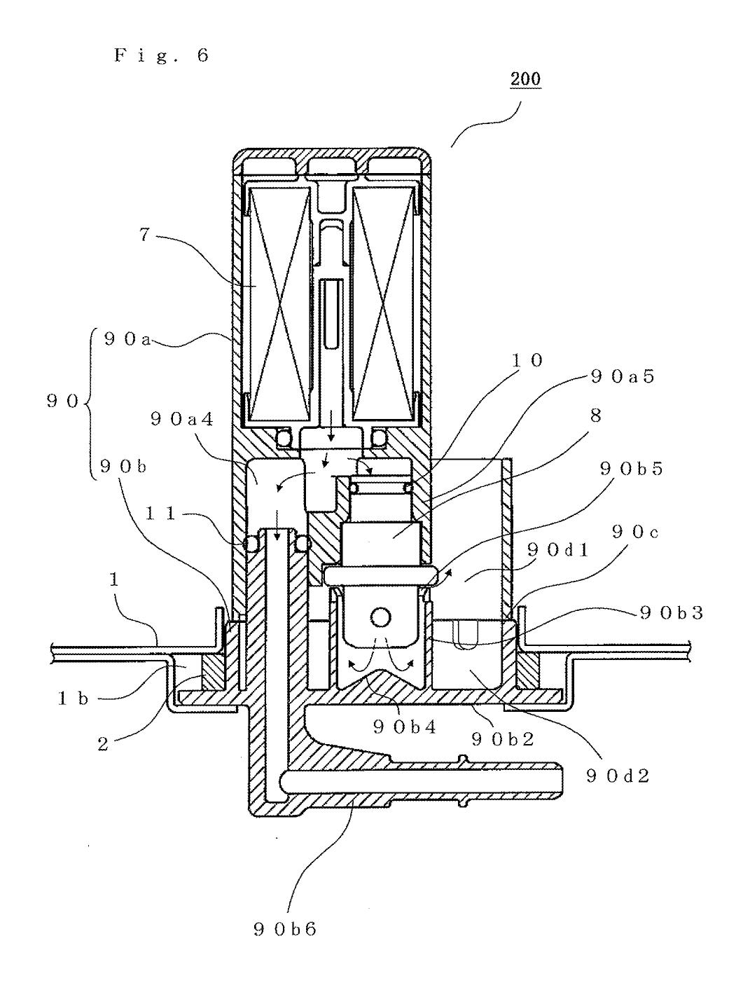

A second embodiment of the invention will be described on the basis of FIG. 6. FIG. 6 is a cross section showing a fuel supply equipment according to the second embodiment of the invention.

The first embodiment above has described a case where the flange 4 serving as the lid member is formed of an iron plate in a disc shape and the second case 9b is formed as one component so that the first case 9a and the second case 9b are supported on the flange 4 by the attachment stay 4c serving as a supporting member. By contrast, the second embodiment will describe a case where a flange serving as a lid member and a second case are integrally molded using thermoplastic resin.

In a fuel supply equipment 200 of FIG. 6, a case 90 is formed of a first case 90a and a second case 90b and made of thermoplastic resin, such as nylon resin and polyacetal resin. The first case 90a accommodates a fuel pump 5 not shown herein and a fuel filter 7. The second case 90b accommodates a suction filter 6 and a pressure regulator 8.

The second case 90b is integrally molded with a lid member that covers an opening 1b of the fuel tank 1 and, as in the first embodiment above, air bubble suppressing members 90b3 and 90b4 that suppress air bubbles in excess fuel discharged from a pressure regulator 8 are integrally molded with the second case 90b.

The second case 90b has an integrally-molded fuel discharge pipe 90b6. The first case 90a and the second case 90b are molded into one piece by fixedly attaching the second case 90b and the first case 90a liquid-tightly on a welding surface 90c by thermal welding, such as thermal plate welding, spin welding, and ultrasonic welding, after the fuel discharge pipe 90b6 is fit by insertion into a first discharge portion 90a4 in the first case 90a via an O-ring 11 and the upper side of the pressure regulator 8 is fit by insertion into a second discharge portion 90a5.

In the fuel supply equipment 200 configured as above, foreign matter in fuel discharged from the fuel pump 5 is removed while the fuel flows through a filter element 7a of the fuel filter 7. Fuel discharged from the fuel filter 7 is then adjusted to have a predetermined pressure by the pressure regulator 8 and discharged to the outside of the fuel tank 1 from the fuel discharge pipe 40a. The fuel is supplied further to injectors or the like of the internal combustion engine not shown herein.

In a case where a pressure of the fuel discharged from the fuel filter 7 is higher than a predetermined value, excess fuel is returned, for example, into spaces 90d1 and 90d2 formed in the vicinity of the welding surface 90c between the first case 90a and the second case 90b by the pressure regulator 8, so that the pressure is maintained at the predetermined value.

An operation for excess fuel discharged from the pressure regulator 8 to be returned into the spaces 90d1 and 90d2 formed in the vicinity of the welding surface 90c between the first case 90a and the second case 90b and accumulated therein will now be described.

A convection flow is developed by the air bubble suppressing members 90b3 and 90b4. Hence, not only are air bubbles contained in the excess fuel discharged from the pressure regulator 8 reduced but also air bubbles become smaller. The excess fuel in this state flows into the spaces 90d1 and 90d2 from a top space 90b5 in the air bubble suppressing member 90b3.

The excess fuel discharged from the pressure regulator 8 flows into the spaces 90d1 and 90d2 from the top space 90b5 in the air bubble suppressing member 90b3. However, a channel is narrowed immediately before the top space 90b5 in the air bubble suppressing member 90b3. Accordingly, the excess fuel flows into the spaces 90d1 and 90d2 from the top space 90b5 in the air bubble suppressing member 90b3 in a state where air bubbles contained therein are made further smaller or reduced more.

In addition, air bubbles remaining in the excess fuel flown into the spaces 90d1 and 90d2 from the top space 90b5 in the air bubble suppressing member 90b3 are lighter than fuel. Accordingly, air bubbles rise up in the spaces 90d1 and 90d2. That is to say, air bubbles rise up to a position remote from the suction filter 6. It thus becomes possible to reduce a possibility that remaining air bubbles are substantially sucked into the suction filter 6.

With the fuel supply equipment 200 according to the second embodiment of the invention configured as above, each of the first case 90a and the second case 90b is made of thermoplastic resin and the first case 90a and the second case 90b are fixedly attached to each other by thermal welding. Hence, not only can the attachment stay 4c serving as a supporting member described above be omitted, but also the second case 90b can be compact. The need of the second case 9b in the first embodiment above can be therefore eliminated in the independent configuration. Accordingly, it becomes possible to obtain a fuel supply equipment 200 that not only reduces the number of components and an initial cost, such as a mold cost, but also has a simple structure and high rigidity.

While the presently preferred embodiments of the present invention have been shown and described. It is to be understood that these disclosure are for the purpose of illustration and that various changes and modifications may be made without departing from the scope of the invention as set forth in the appended claims.

What is claimed is:

1. A fuel supply equipment attached to a bottom wall of a fuel tank storing fuel, comprising:
a lid member filled in an opening made in the bottom wall and provided with a fuel discharge pipe;
a fuel pump held by the lid member and configured to suck in the fuel within the fuel tank and discharge the fuel to an outside of the fuel tank from the fuel discharge pipe;
a suction filter provided on a suction side of the fuel pump to filter the fuel within the fuel tank that will be sucked into the fuel pump;
a fuel filter provided on a discharge side of the fuel pump to remove foreign matter in the fuel discharged from the fuel pump;
a pressure regulator configured to adjust a pressure of the fuel discharged from the fuel filter to a predetermined pressure and discharge excess fuel of the fuel;
a case configured to accommodate the fuel pump, the suction filter, the fuel filter, and the pressure regulator and accumulate therein the excess fuel discharged from the pressure regulator; and
a supporting member provided to the lid member to support the case on the lid member.

2. The fuel supply equipment according to claim 1, wherein:
the case is formed of a first case that accommodates the fuel pump and the fuel filter and a second case that accommodates the pressure regulator and the suction filter; and
the first case and the second case are latched by a latching means.

3. The fuel supply equipment according to claim 2, wherein:
the second case includes an air bubble suppressing member that suppresses air bubbles in the excess fuel discharged from the pressure regulator.

4. The fuel supply equipment according to claim 3, wherein:
the air bubble suppressing member is formed of a tubular body provided to a discharge portion of the excess fuel of the pressure regulator and a conical body provided consecutively with a bottom portion of the tubular body.

5. A fuel supply equipment attached to a bottom wall of a fuel tank storing fuel, comprising:
a lid member filled in an opening made in the bottom wall and provided with a fuel discharge pipe;
a fuel pump held by the lid member and configured to suck in the fuel within the fuel tank and discharge the fuel to an outside of the fuel tank from the fuel discharge pipe;
a suction filter provided on a suction side of the fuel pump to filter the fuel within the fuel tank that will be sucked into the fuel pump;
a fuel filter provided on a discharge side of the fuel pump to remove foreign matter in the fuel discharged from the fuel pump;
a pressure regulator configured to adjust a pressure of the fuel discharged from the fuel filter to a predetermined pressure and discharge excess fuel of the fuel; and
a case configured to accommodate the fuel pump, the suction filter, the fuel filter, and the pressure regulator and accumulate therein the excess fuel discharged from the pressure regulator,
wherein the lid member and the case are made of thermoplastic resin and the lid member and the case are fixedly attached to each other by thermal welding.
